(19) United States
(12) Patent Application Publication
(10) Pub. No.: US 2008/0171181 A1
(43) Pub. Date: Jul. 17, 2008

(54) High-current traces on plated molded interconnect device

(75) Inventor: Victor Zaderej, St. Charles, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/652,361

(22) Filed: Jan. 11, 2007

(51) Int. Cl. B32B 3/00; B29C 59/00; B29C 41/22; B29D 31/00; B32B 15/08

(52) U.S. Cl. 428/209; 264/129; 264/446; 264/430; 428/195.1

(57) ABSTRACT

A molded interconnect device with a high-current trace and methods of making a molded interconnect device with a high-current trace are described. The molded interconnect device comprises a substrate surface and an interconnect pattern. The interconnect pattern is at least one of a rib raised from the substrate surface and a channel protruding into the substrate surface. In a first embodiment, the molded interconnect device is molded from photosensitive plastic molded in a one-shot molding process. A trace is grown on the portion of the interconnect pattern where an interconnect path has been written, either by a laser or by photolithography. In a second embodiment, the molded interconnect device is molded of plastic and the trace is grown by at least one of a mask and print-and-plate process and a mask and print-and-etch process. The trace forms at least one of an angle and a curve in cross section.

### FIELD OF THE INVENTION

This invention relates to the field of molded interconnect devices [“MIDs”]. A MID has at least one electrical trace grown, usually by plating of a conductive metal, on a molded plastic structure. The trace carries data signals, control signals, or power to and from components of the application. MIDs are used in a variety of industries as, for examples, sensors, switches, connectors, instrument panels, and controllers.

### BACKGROUND OF THE INVENTION

In the prior art, MIDs were created by molding part of a structure in one mold, using a first plastic material, then placing the structure in a second mold and shooting again with a second plastic material. The two plastic materials are selected so that a conductive material can be plated on one of the plastic materials and not on the other plastic material. The conductive material, grown on the platable plastic, becomes a trace. A representative method of two-shot molding is described in U.S. Pat. No. 5,359,165, Illuminated Rotary Switch Assembly. While the two-shot molding process works well, it is expensive and time-consuming.

More recent developments in plastic injection molding permit molding of MIDs in a single shot. For example, a structure can be produced from a single photosensitive plastic material, such as, for example, a plastic doped with an organic metal complex. An interconnect path is then written on the molded structure by, for example, a laser, which breaks the metal atoms from the organic ligands, allowing the metal atoms to act as nuclei for reductive copper plating, as well as ablating the plastic surface. Immersion in a copper bath permits plating of copper onto the areas etched by the laser beam, growing traces in those areas.

The prior art also describes creating traces by photolithography and by plating and etching, both of which can be adapted to use on a molded interconnect device.

The amount of current that can be carried by a trace is a function of the cross-sectional area of the conductor and the allowable temperature rise. To increase the cross-sectional area, either the depth of the trace or the width of the trace must be increased. The costs of the plating process usually limit increasing the depth of the trace. A desire for smaller components and scarce space for applications usually limits the width of the trace.

A need exists for an MID having traces with increased current-carrying capability without increasing plating costs or width of the trace. The present invention meets this need.

### SUMMARY OF THE INVENTION

The present invention is a molded interconnect device having a high-current trace and a method for making a molded interconnect device with a high-current trace. In a first embodiment, the MID comprises a substrate surface and an interconnect pattern. The interconnect pattern is at least one of a rib raised from the substrate surface and a channel protruding into the substrate surface. The MID is preferably formed from a photosensitive material in a one-shot molding process. An interconnect path is written on at least a portion of the interconnect pattern and a trace is grown on the interconnect path, forming at least one of an angle and a curve in cross section. The interconnect path is preferably written by a laser or by a photolithography process.

In a second embodiment, the invention comprises the steps of molding a MID of a photosensitive plastic, the MID having a substrate surface and an interconnect pattern comprising at least one of a rib raised from the substrate surface and a channel protruding into the substrate surface, writing an interconnect path on at least a portion of a surface of the interconnect pattern, preferably by a laser or by a photolithography process, and growing a trace on the interconnect path, the trace forming at least one of an angle and a curve in cross section.

In yet another embodiment, the MID comprises a substrate surface and an interconnect pattern. The interconnect pattern is at least one of a rib raised from the substrate surface and a channel protruding into the substrate surface. The trace is grown on at least a portion of the interconnect pattern by at least one of a masking and print-and-plate process and a masking and print-and-etch process, the trace forming at least one of an angle and a curve in cross section.

In yet another embodiment, the invention comprises the steps of molding a MID of plastic, the MID comprising a substrate surface and an interconnect pattern, the interconnect pattern comprising at least one of a rib raised from the substrate surface and a channel protruding into the substrate surface, and growing a trace on at least a portion of the interconnect pattern by at least one of a masking and print-and-plate process and a masking and print-and-etch process, the trace forming at least one of an angle and a curve in cross section.

### BRIEF DESCRIPTION OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a cross-sectional view of a molded interconnect device and a trace as known in the prior art.

FIG. 2 is a cross-sectional view of the MID and the trace of the preferred embodiment of the invention.

FIG. 3 is a cross-sectional view of the MID and the trace of another embodiment of the invention.

FIG. 4 is a cross-sectional view of the MID and the trace of yet another embodiment of the invention.

FIG. 4A is a cross-sectional view of the MID and the trace of FIG. 4, illustrating multiple traces on a single raised surface.

FIG. 5 is a cross-sectional view of the MID and the trace of yet another embodiment of the invention.

FIG. 6 is a cross-sectional view of the MID and the trace of yet another embodiment of the invention.

FIG. 7 is a flow chart of the method of manufacture of the MID and the trace of the preferred embodiment of the invention.

FIG. 8 is a flow chart of the method of manufacture of the MID and the trace of another embodiment of the invention.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

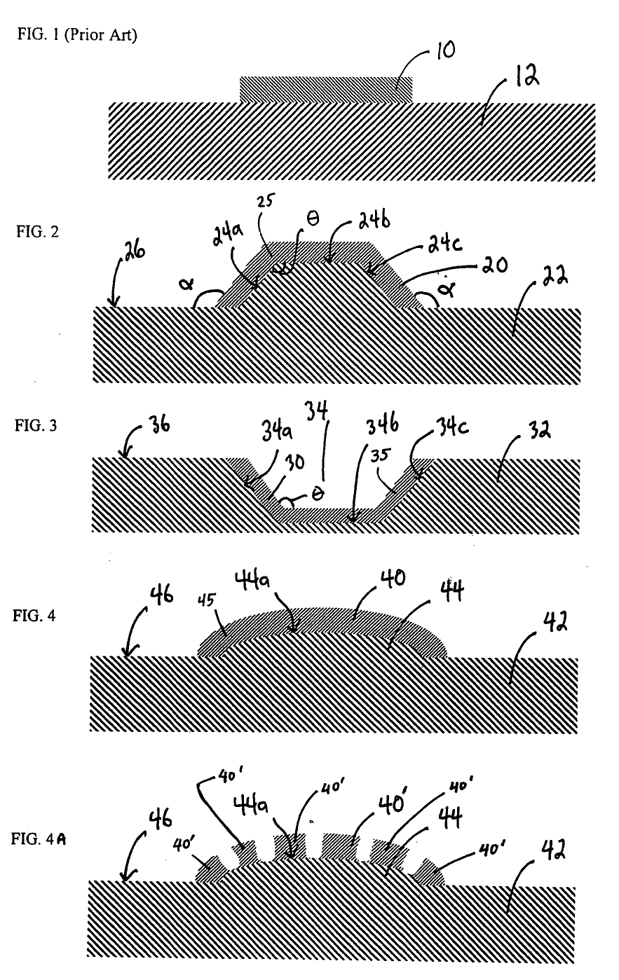

A trace 10 on a molded interconnect device such as MID 12, as is known in the prior art, is shown in cross-sectional view in FIG. 1. Trace 10 is made of a conductive material, such as copper, which has been grown, usually by plating, on the substrate of MID 12. The amount of current that can be carried by trace 10, at a given temperature for the application in which it is used, is limited by the depth and width of trace 10.

A high-current trace 20 of the preferred embodiment of the present invention is shown in cross-sectional view in FIG. 2. Molded interconnect device 22 is preferably made of a photosensitive material by a one-shot molding process. MID 22 has an interconnect pattern that is a raised rib 24, having surfaces 24a, 24b, and 24c. In this embodiment, rib 24 is trapezoidal in cross-section. Rib 24 protrudes from the substrate surface 26 of MID 22. A conductive material 25, preferably copper, is grown on surfaces 24a, 24b, and 24c, which in this embodiment are flat, to create trace 20. Trace 20 is preferably grown by plating onto an interconnect path written on at least a portion of the interconnect pattern. The interconnect path has been written by a laser or other illuminator as described herein. Accordingly, while trace 20 has an apparent width relative to MID 22 that is approximately the same as the width of trace 10 of the prior art, and a depth of metal that is approximately the same as the depth of the metal of trace 10, the cross-sectional area of trace 20 is significantly larger than the cross-sectional area of trace 10.

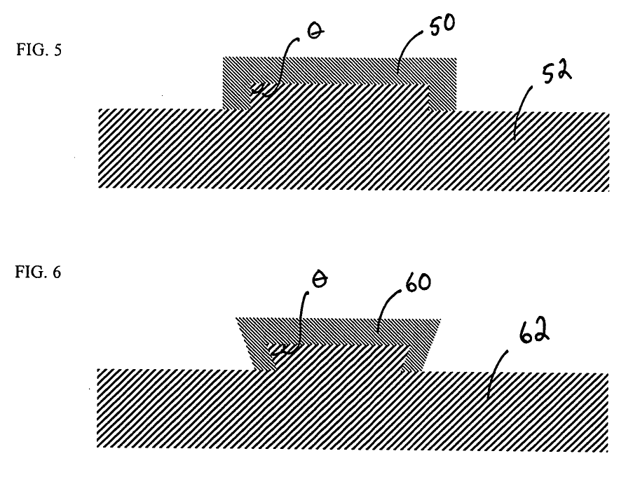

A high-current trace 30 of a second embodiment of the present invention is shown in cross-sectional view in FIG. 3. Molded interconnect device 32 is preferably made of a photosensitive material by a one-shot molding process. MID 32 has an interconnect pattern that is a channel 34, having surfaces 34a, 34b, and 34c, which in this embodiment are flat, recessed into the substrate surface 36 of MID 32. In this embodiment, channel 34 is trapezoidal in cross-section. A conductive material 35, preferably copper, is grown on surfaces 34a, 34b, and 34c, which in this embodiment are flat, to create trace 30. Trace 30 is preferably grown by plating onto an interconnect path written on at least a portion of the interconnect pattern. The interconnect path has been written by a laser or other illuminator as described herein. Accordingly, while trace 30 has an apparent width relative to MID 32 that is approximately the same as the width of trace 10 of the prior art, and a depth of that is approximately the same as the depth of the metal of trace 10, the cross-sectional area of trace 30 is significantly larger than the cross-sectional area of trace 10.

In yet another embodiment, a curved surface is used. A high-current trace 40 of a third embodiment of the present invention is shown in cross-sectional view in FIG. 4. Molded interconnect device 42 is preferably made of a photosensitive material by a one-shot molding process. MID 42 has an interconnect pattern that is a raised rib 44 protruding from the substrate surface 46. In this embodiment, rib 44 is ovate in cross-section and has a surface 44a, which in this case is a single, curved surface. A conductive material 45, preferably copper, is grown on surface 44a, to create trace 40. Trace 40 is grown preferably by plating onto an interconnect path written on at least a portion of the interconnect pattern. The interconnect path has been written by a laser or other illuminator as described herein. Accordingly, while trace 40 has an apparent width relative to MID 42 that is approximately the same as the width of trace 10 of the prior art, and a depth of metal that is approximately the same as the depth of the metal of trace 10, the cross-sectional area of trace 40 is significantly larger than the cross-sectional area of trace 10.

As shown in FIG. 4A, a single raised surface 44 can have multiple traces 40′ associated with in. This is particularly useful for increasing the surface area for routing multiple, fine pitched signal traces, or in other situations where multiple traces are desirable.

The manufacture of traces 20, 30, 40 does not lead to significant increases in costs for plating, as the depth of metal of each of trace 20, 30, 40 can be about the same as the depth of the metal of a similar trace used in the prior art. Similarly, the apparent width of traces 20, 30, 40 on MID 22, 32, 42 is the same as the width of a similar trace used in the prior art, so the size of the application need not change. But, at a given operating temperature, traces 20, 30, 40 can carry a significantly higher current than can trace 10 of the prior art, as a result of the increased cross-sectional area of traces 20, 30, 40.

The cross-sectional shapes of rib 24, channel 34, and rib 44 are preferred embodiments and not limitations. The rib or channel of the present invention can have any cross-sectional shape desired, including but not limited to triangular, trapezoidal, square, rectangular, rhombic, parallelogram, higher-order polygonal, hemispherical, hemi-elliptical, ovate, or irregular.

Please also note that in the preferred embodiments, the interconnect pattern is one of a rib and a channel, but an interconnect pattern that is partially a rib and partially a channel could be used as well.

In the preferred embodiment, sides 24a and 24c each form obtuse angles a with substrate surface 26. Angle α is preferably 105 to 110 degrees, but more obtuse angles, less obtuse angles, right angles, or acute angles are also possible. Trace 50, an embodiment having right angles, is shown in cross-sectional view in FIG. 5 on MID 52. Trace 60, an embodiment having acute angles, is shown in FIG. 6 on MID 62. Embodiments are also possible in which different angles are used, such as a right angle on one side and an obtuse angle on the other side. Embodiments are also possible in which mixes of flat portions and curved portions of rib 24 are used. The same considerations apply to embodiments having channels.

In the preferred embodiment, the entire surface of rib 24 is covered with a conductive material. In another embodiment, only part of rib 24 is covered. For example, trace 20 could be grown on sides 24a and 24b only of rib 24. Furthermore, only a portion of the interconnect pattern could be covered. For examples, trace 20 could be grown on side 24b and only portions of sides 24a and 24c, or trace 40 could be grown on only a portion of surface 44a. In all embodiments, however, trace 20, 30, 40 does not have a rectangular cross section as does trace 10 of the prior art, but forms at least one angle or curve in cross section. For example, traces 20, 30, 50, and 60 each form an angle θ in cross section, whereas trace 40 forms a curve in cross section.

Attention is now turned to the methods of manufacture of the molded interconnect device with a high-current trace. The methods will be described for manufacture of a MID 22 having a high-current trace 20, but the method can be used for manufacture of any trace on any MID, including but not limited to traces 30, 40, 50, and 60.

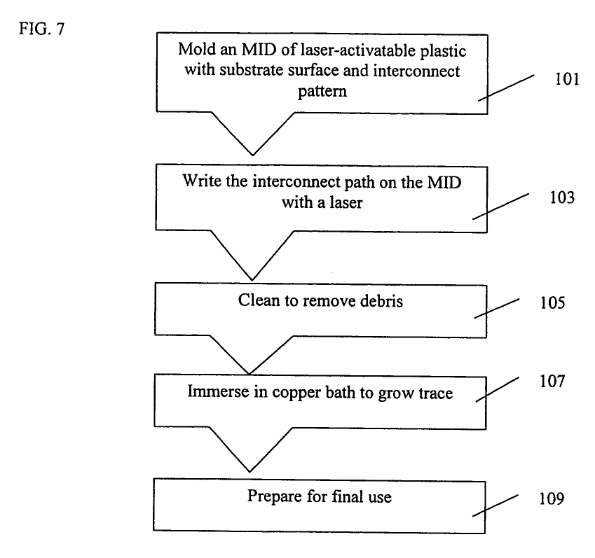

In a first embodiment, as shown in flow-chart form in FIG. 7, the interconnect path is laser imaged. MID 22, having an interconnect pattern of rib 24, is preferably produced using a one-component injection molding process, most preferably the process of LPKF Laser & Electronics AG of Garbsen, Germany (see Step 101 on FIG. 7). MID 22 is preferably made of a photosensitive plastic having high thermal shape stability, including but not limited to semi-aromatic polyamide, thermoplastic polyester, cross-linked polybutylenterephlate (PBT), liquid crystal polymer (LCP), polycarbonate/acrylnitrile/butadiene/styrol (PC/ABS), or nylon. The plastic is photosensitive because it is doped, in a first embodiment, with a non-conductive organic metal complex. In another embodiment, the plastic is doped with a non-conductive spinel-based metal oxide, such as described in U.S. Pat. No. 7,060,421, Conductor Track Structures and Method for Production Thereof, the disclosure of which is incorporated herein by reference. Other types of photosensitive material can be used.

The interconnect path of trace 20 is then written on rib 24 (Step 103). In a first embodiment, a focused laser is used. The laser beam breaks the metal atoms from the organic ligands of the organic metal complex, or reduces the metal of the spinel-based metal oxide, and creates a microscopically irregular surface. The laser beam preferably writes the interconnect path on all three protruding sides 24a, 24b, 24c of rib 24. If necessary, MID 22 can be rotated, tilted, or otherwise oriented with respect to the laser source to ensure proper laser marking of all portions of surfaces to be plated. The laser beam can also write the interconnect path on only portions of the surface of rib 24 if desired for the end application.

MID 22 is next cleaned to remove debris (Step 105), preferably by use of demineralized water. Next, trace 20 is grown on the interconnect pattern by immersion of MID 22 in a current-free bath, preferably a current-free copper bath (Step 107). The metal will plate only on the portions of MID 22 that have been written by the laser.

In the preferred embodiment, trace 20 can be grown to a depth of three to five millimeters. In another embodiment, a standard electroforming bath, preferably an electroforming copper bath, can be used to grow trace 20 to a deeper depth. In yet other embodiments, other metals can be used, including but not limited to nickel, gold, tin, lead, silver, palladium, and alloys of these metals.

MID 22 can now be prepared for final use, by such steps as stencil printing, dispensing, component assembly, and chip contacting (Step 109).

In a second embodiment, trace 20 is manufactured by photolithography. First, MID 22, having an interconnect pattern of rib 24, is produced, preferably using a one-component injection molding process, most preferably the process of LPKF Laser & Electronics AG of Garbsen, Germany (see Step 101 on FIG. 7). MID 22 is preferably made of a photosensitive plastic. Alternatively, only the surface of MID 22 can be made of a photosensitive plastic. An illuminator than writes the interconnect path of trace 20 on rib 24 using photolithography (step 103) such as the process described in U.S. Pat. No. 5,822,042, Three Dimensional Imaging System, the disclosure of which is incorporated herein by reference. The illuminator can write the interconnect path on the entire surface of rib 24 or only on portions of the surface of rib 24, as desired for the end application. Trace 20 is then grown on the interconnect path as described above (steps 105, 107, and 109).

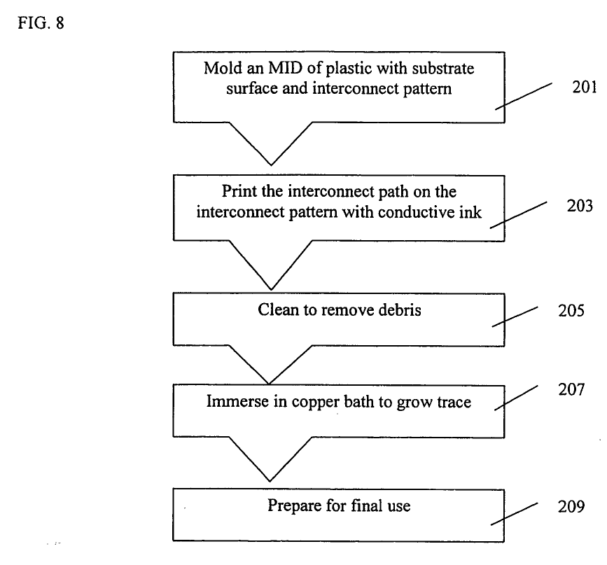

In yet another embodiment, trace 20 is manufactured by plating or etching, as shown in flow-chart form in FIG. 8. First MID 22, having an interconnect pattern of rib 24, is produced by a conventional injection molding system (step 201 of FIG. 8). A mask is molded into the topological shape of MID 22, from a plastic sheet printed with vacuum-formable ink and imaged with a laser. Trace 20 is then created on MID 22 either by a print-and-plate process or by a print-and-etch process, such as the processes described in U.S. Pat. No. 4,985,116, Three Dimensional Plating or Etching Process and Mask Therefor, the disclosure of which is incorporated herein by reference (step 203).

While preferred embodiments of the present invention are shown and described, it is envisioned that those skilled in the art may devise various modifications of the present invention without departing from the spirit and scope of the appended claims.

The invention that is claimed is:

1. A molded interconnect device, comprising:
a photosensitive material molded in a one-shot molding process, said material comprising a substrate surface and an interconnect pattern, said interconnect pattern comprising at least one of a rib raised from said substrate surface and a channel protruding into said substrate surface, said interconnect pattern having a surface; and
a trace grown on at least a portion of said interconnect pattern surface and forming at least one of an angle and a curve in cross section.

2. The molded interconnect device of claim 1, wherein said interconnect pattern has a plurality of surfaces and said trace is formed on at least a portion of at least one of said plurality of surfaces.

3. The molded interconnect device of claim 1, wherein said interconnect pattern has a cross-sectional shape selected from the group consisting of triangular, trapezoidal, square, rectangular, rhombic, parallelogram, higher-order polygonal, hemispherical, hemi-elliptical, ovate, and irregular.

4. The molded interconnect device of claim 1, wherein said trace is grown by plating.

5. The molded interconnect device of claim 4, wherein said trace comprises a material selected from the group consisting of copper, nickel, gold, tin, lead, silver, and palladium.

6. The molded interconnect device of claim 4, wherein said trace comprises an alloy comprising at least two of the materials selected from the group consisting of copper, nickel, gold, tin, lead, silver, and palladium.

7. The molded interconnect device of claim 1, wherein said plastic comprises at least one of semi-aromatic polyamide, thermoplastic polyester, cross-linked polybutylenterephlate, liquid crystal polymer, polycarbonate/acrylnitrile/butadiene/styrol, and nylon.

8. The molded interconnect device of claim 1, wherein said photosensitive plastic is a plastic doped with at least one of a non-conductive spinel-based metal oxide and an organic metal complex.

9. The molded interconnect device of claim 1, wherein said photosensitive plastic is activated by at least one of a laser and a photolithography system.

10. The molded interconnect device of claim 1, having multiple raised surfaces.

11. The molded interconnect device of claim 1, having multiple channels.

12. The molded interconnect device of claim 1, wherein said at least one of a rib raised from said substrate surface and a channel protruding into said substrate surface includes a plurality of traces.

13. A method of making a molded interconnect device, comprising:
molding a photosensitive material in a one-shot molding process, said photosensitive material comprising a substrate surface and an interconnect pattern, said interconnect pattern comprising at least one of a rib raised from said substrate surface and a channel protruding into said substrate surface, said interconnect pattern having a surface;
writing an interconnect path on at least a portion of said surface of said interconnect pattern; and
growing a trace on said interconnect path, said trace forming at least one of an angle and a curve in cross section.

14. The method of claim 13, wherein said interconnect pattern has a plurality of surfaces and said interconnect path comprises at least a portion of at least one of said plurality of surfaces.

15. The method of claim 13, wherein said interconnect pattern has a cross-sectional shape selected from the group consisting of triangular, trapezoidal, square, rectangular, rhombic, parallelogram, higher-order polygonal, hemispherical, hemi-elliptical, ovate, and irregular.

16. The method of claim 13, wherein said growing step comprises plating.

17. The method of claim 13, wherein said growing step comprises using a current-free bath.

18. The method of claim 13, wherein said growing step comprises using an electroforming bath.

19. The method of claim 10, wherein said plastic comprises at least one of semi-aromatic polyamide, thermoplastic polyester, cross-linked polybutylenterephlate, liquid crystal polymer, polycarbonate/acrylnitrile/butadiene/styrol, and nylon.

20. The method of claim 13, wherein said photosensitive plastic comprises plastic doped with at least one of a non-conductive spinel-based metal oxide and an organic metal complex.

21. The method of claim 13, wherein said writing step comprises at least one of using a laser beam and photolithography.

22. A molded interconnect device, comprising:
a substrate surface and an interconnect pattern, said interconnect pattern comprising at least one of a rib raised from said substrate surface and a channel protruding into said substrate surface, said interconnect pattern having a surface; and
a trace grown on at least a portion of said interconnect pattern by at least one of a masking and print-and-plate process and a masking and print-and-etch process, said trace forming at least one of an angle and a curve in cross section.

23. The molded interconnect device of claim 22, wherein said interconnect pattern has a plurality of surfaces and said trace is grown on at least a portion of at least one of said plurality of surfaces.

24. The molded interconnect device of claim 22, wherein said interconnect pattern has a cross-sectional shape selected from the group consisting of triangular, trapezoidal, square, rectangular, rhombic, parallelogram, higher-order polygonal, hemispherical, hemi-elliptical, ovate, and irregular.

25. The molded interconnect device of claim 22, wherein said conductor comprises a material selected from the group consisting of copper, nickel, gold, tin, lead, silver, and palladium.

26. A method of making a molded interconnect device, comprising:
molding a substrate surface and an interconnect pattern comprising at least one of a rib raised from said substrate surface and a channel protruding into said substrate surface, said interconnect pattern having a surface;
growing a trace on at least a portion of said interconnect pattern by at least one of a masking and print-and-plate process and a masking and print-and-etch process, said trace forming at least one of an angle and a curve in cross section.

27. The method of claim 26, wherein said interconnect pattern has a plurality of surfaces and said interconnect path is written on at least a portion of at least one of said plurality of surfaces.

28. The method of claim 26, wherein said interconnect pattern has a cross-sectional shape selected from the group consisting of triangular, trapezoidal, square, rhombic, higher-order polygonal, hemispherical, ovate, and irregular.

29. The method of claim 26, wherein said trace comprises a material selected from the group consisting of copper, nickel, gold, tin, lead, silver, and palladium.

30. The method of claim 26, wherein said trace comprises an alloy comprising at least two of the materials selected from the group consisting of copper, nickel, gold, tin, lead, silver, and palladium.
